(19) United States
(12) Patent Application Publication
(10) Pub. No.: US 2013/0235261 A1
(43) Pub. Date: Sep. 12, 2013

(54) Plenoptic Imaging System with a Body and Detachable Plenoptic Imaging Components

(71) Applicants: Kathrin Berkner, Los Altos, CA (US); Sapna A. Shroff, Menlo Park, CA (US)

(72) Inventors: Kathrin Berkner, Los Altos, CA (US); Sapna A. Shroff, Menlo Park, CA (US)

(73) Assignee: RICOH CO., LTD., Tokyo (JP)

(21) Appl. No.: 13/414,690

(22) Filed: Mar. 7, 2012

(51) Int. Cl. H04N 5/225

(52) U.S. Cl. 348/374; 348/E05.026

(57) ABSTRACT

A modular plenoptic imaging system, in which various components of the plenoptic imaging system can be detachably attached to each other. In this way, various primary lenses, filter modules, microlens arrays and/or sensor arrays can be interchanged.

### BACKGROUND OF THE INVENTION

1. Field of the Invention

This invention relates generally to plenoptic imaging systems, and more particularly to plenoptic imaging systems with a body and detachable components.

2. Description of the Related Art

The plenoptic imaging system has recently received increased attention. It can be used to recalculate a different focus point or point of view of an object, based on digital processing of the captured plenoptic image. The plenoptic system also finds application in multi-modal imaging, using a multi-modal filter array in the plane of the pupil aperture. Each filter is imaged at the sensor, effectively producing a multiplexed image of the object for each imaging modality at the filter plane. Other applications for plenoptic imaging systems include varying depth of field imaging and high dynamic range imaging.

However, traditional plenoptic imaging systems are typically fixed designs. The plenoptic imaging system is designed and then constructed as an integrated unit. It is difficult to change the major optical components in the plenoptic imaging system after it has been constructed. However, different situations require plenoptic imaging systems of different designs. For example, different object specifications (desired resolution, field of view, depth range) may require the use of different primary lenses in an SLR camera. Each primary lens, in turn, may require a different lenslet array matched to the primary lens.

Therefore, there is a need for plenoptic imaging systems which are modular in design and which can be reconfigured in the field.

### SUMMARY OF THE INVENTION

The present invention overcomes various limitations by providing a modular plenoptic imaging system, in which various components of the plenoptic imaging system can be detached. In this way, various primary lenses, filter modules, microlens arrays and/or sensor arrays can be interchanged.

In one aspect, a common body is used to host various plenoptic combinations. The body itself may also implement additional functions, such as user controls, interfaces for portable media or for communications protocols, and/or to provide power to the plenoptic components. The body and plenoptic components may have corresponding electrical interfaces that engage when the body and components are attached to each other.

In one variant, the body can also be used for conventional imaging applications. For example, the various plenoptic components may be designed to work with a standardized camera body.

Other aspects of the invention include methods, devices and systems corresponding to the concepts described above, and applications for the foregoing.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a simplified diagram of a plenoptic imaging system.

FIG. 2 is a block diagram illustrating object reconstruction from a plenoptic image.

FIGS. 3a-c are block diagrams illustrating different modes using feedback based on error in the object estimate.

FIGS. 4a-b are block diagrams illustrating PIF inversion used for substance detection and for depth estimation, respectively.

FIG. 5 is a front oblique view of a camera body attached to a plenoptic imaging unit.

FIG. 6 is a front oblique view of a camera body detached from a plenoptic imaging unit.

FIG. 7 is a rear view of the plenoptic imaging unit.

FIG. 8 is a bottom view illustrating how the plenoptic imaging unit is attached to the camera body.

FIGS. 9a-b are views showing engagement of corresponding sheet metal members of the camera body and plenoptic imaging unit.

FIG. 10 is a block diagram showing the electrical connections between a plenoptic imaging unit and a camera body.

FIG. 11 is a block diagram showing the electrical connections between another plenoptic imaging unit and a camera body.

FIGS. 12a-d are diagrams depicting different types of interchangeability.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

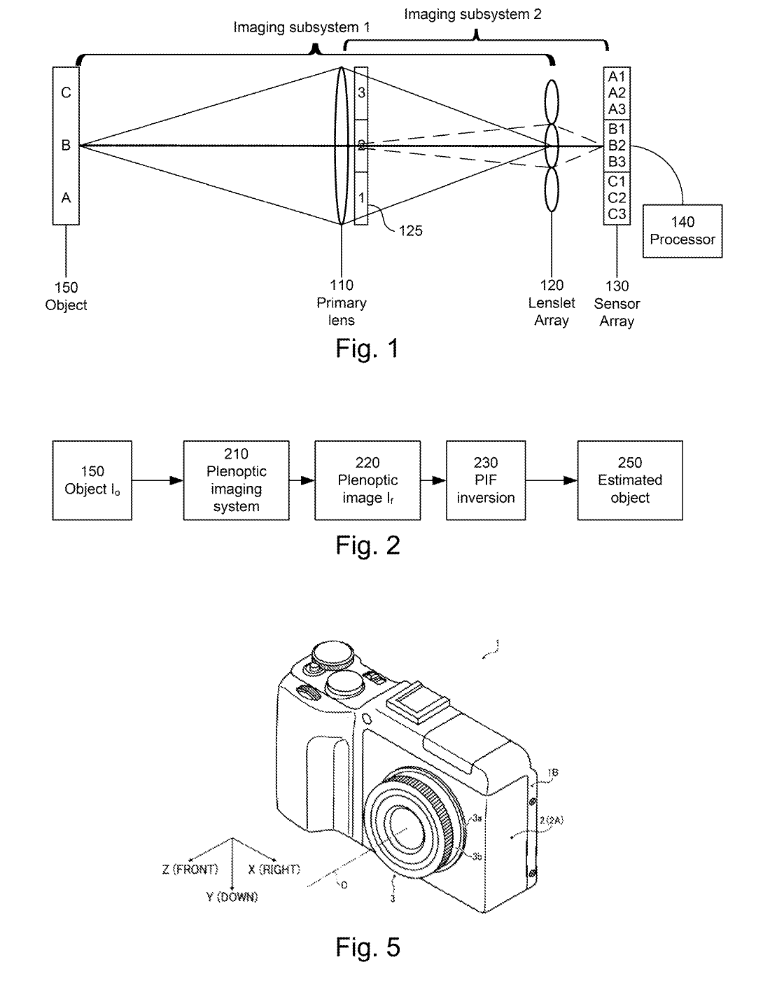

FIG. 1 is a simplified diagram of a plenoptic imaging system. The system includes a primary imaging subsystem 110 (represented by a single lens in FIG. 1), a secondary imaging array 120 (represented by a lenslet array) and a sensor array 130. These form two overlapping imaging subsystems, referred to as subsystem 1 and subsystem 2 in FIG. 1. The plenoptic imaging system optionally may have a filter module 125 positioned at a location conjugate to the sensor array 130. The filter module contains a number of spatially multiplexed filter cells, labeled 1-3 in FIG. 1. For example, the filter cells could correspond to different modalities within the object.

In FIG. 1, the different components are each represented by a single element located at a single plane. This is done for purposes of clarity. It should be understood that the different components may be more complex than shown. For example, the “primary lens” 110 could be various combinations of elements, including lenses, mirrors and combinations thereof. Similarly, the secondary imaging array 120 could be a pinhole array or a reflective array, in addition to a microlens array.

Ignoring the filter module 125 for the moment, in imaging subsystem 1, the object 150 is imaged by the primary lens 110 to produce an image that will be referred to as the “primary image.” This primary lens 110 may be a camera imaging lens, microscope objective lens or any other such imaging system. The lenslet array 120 is placed approximately at the location of the primary image. Each lenslet then images the pupil of the primary lens to the sensor plane. This is imaging subsystem 2, which partially overlaps with imaging subsystem 1. The image created at the sensor array 130 will be referred to as the “plenoptic image” in order to avoid confusion with the “primary image.” The plenoptic image can be divided into an array of subimages, corresponding to each of the lenslets. Note, however, that the subimages are images of the pupil of imaging subsystem 1, and not of the object 150. In FIG. 1, the plenoptic image and subimages are labeled A1-C3. A1 generally corresponds to portion A of the object 150, as filtered by filter cell 1 in the filter module 125.

The plenoptic image captured by sensor array 130 does not look like a conventional image. However, it contains information about the object and the lightfield generated by the object, as filtered by filter module 125. This information can be processed using various techniques to recover different types of images or to achieve other goals. In FIG. 1, processor 140 does the processing. Examples of different types of applications and processing are described, for example, in U.S. patent application Ser. Nos. 13/398,815 “Spatial reconstruction of plenoptic images” filed Feb. 16, 2012 (docket 19823); 13/399,476 “Resolution-enhanced plenoptic imaging system” filed filed Feb. 17, 2012 (docket 19820); 13/007,901 “Multi-imaging system with interleaved images” filed Jan. 17, 2011 (docket 17757); and 12/571,010 “Adjustable multimode lightfield imaging system having an actuator for changing position of a non-homogeneous filter module relative to an image-forming optical module” filed Sep. 30, 2009 (docket 15987). All of the foregoing are incorporated by reference herein. Some examples are described below in FIGS. 2-4.

FIG. 2 is a block diagram illustrating object reconstruction from a plenoptic image. An object 150 is incident 210 on a plenoptic imaging system, which captures plenoptic image 220. The image capture process for the plenoptic imaging system is described by a pupil image function (PIF) response. Signal processing 230 is used to invert this process in order to obtain an estimate 250 of the original object. In the case of a filter module, each filter in the module may filter out a different component of the object, and the PIF inversion process 230 can produce estimates 250 of each object component. For example, the object components could represent different wavelength bands within the object. Other components could be based on polarization, attenuation, object illumination or depth, for example. Examples of the PIF inversion process are described in U.S. patent application Ser. Nos. 13/398,815 “Spatial reconstruction of plenoptic images” filed Feb. 16, 2012 (docket 19823); and 13/399,476 “Resolution-enhanced plenoptic imaging system” filed filed Feb. 17, 2012 (docket 19820); which are incorporated by reference in their entirety.

The model shown in FIG. 2 can be used in a number of modes. The description above was for an operational mode of the plenoptic imaging system (as opposed to a calibration, testing or other mode). A plenoptic image is captured, and the goal is to reconstruct a high quality image of the original object (or of an object component) from the captured plenoptic image. This will also be referred to as reconstruction mode.

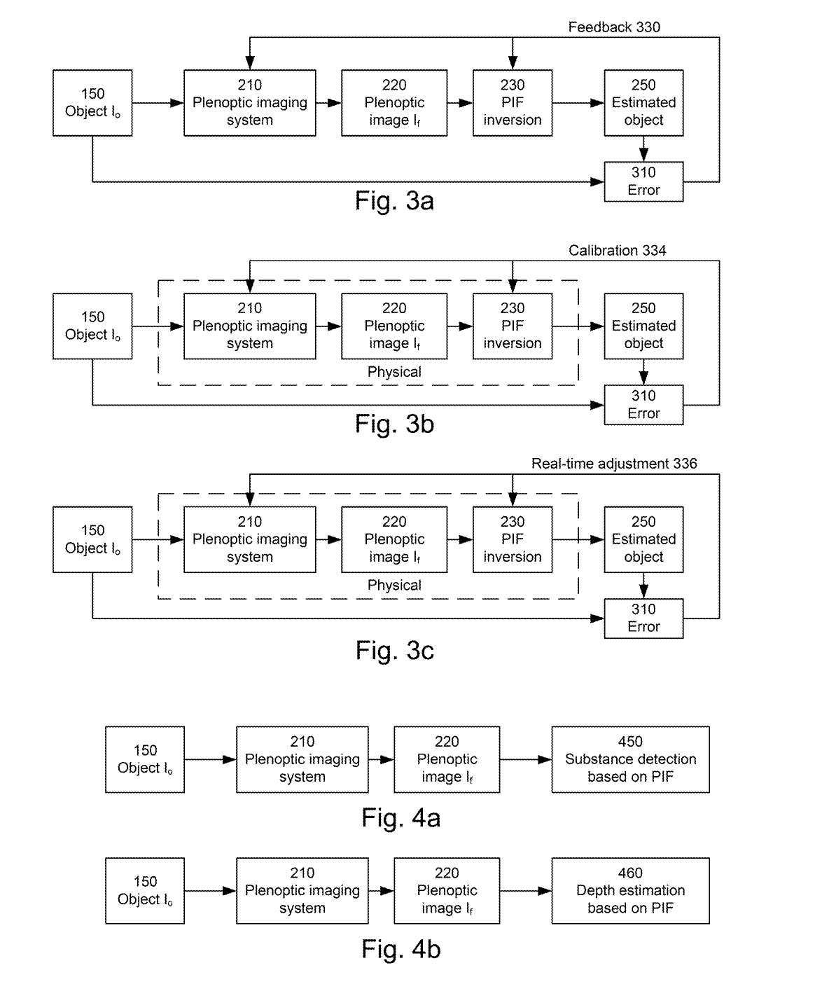

FIG. 3a is a block diagram based on the same PIF model, but used in a different manner. Here, the object 150 is known (or independently estimated) and the estimated object 250 is compared to the actual object. An error metric 310 is calculated and used as feedback 330 to modify the plenoptic imaging system 210 and/or the inversion process 230.

This general model can be used for different purposes. For example, it may be used in an offline calibration mode, as shown in FIG. 3b. In this mode, the plenoptic imaging system has been designed and built, and is being calibrated. This might occur in the factory or in the field. In this example, the object 150 is a known calibration target. The error metric 310 is used to calibrate 334 the already built plenoptic imaging system 210 and/or signal processing 230. Example adjustments may include adjustments to the physical position, spacing or orientation of components; to timing, gain, filter weights, or other electronic attributes.

In FIG. 3c, the feedback loop is similar to FIG. 3b, except that it occurs automatically in real-time 336. This would be the case for auto-adjustment features on the plenoptic imaging system.

In a last variation, FIGS. 3a-c are based on a metric that compares an estimated object 250 with the actual object 150. However, other metrics for estimating properties of the object can also be used, as shown in FIGS. 4a-b. In addition, the PIF model can be used without having to expressly calculate the estimated object.

In FIG. 4a, the task is to determine whether a specific substance is present based on analysis of different spectral components. For example, the PIF model may be based on these different spectral components, with a corresponding filter module used in the plenoptic imaging system. Conceptually, a PIF inversion process can be used to estimate each spectral component, and these can then be further analyzed to determine whether the substance is present. However, since the end goal is substance detection, estimating the actual object components is an intermediate step. In some cases, it may be possible to make the calculation 450 for substance detection without directly estimating the object components. The process shown in FIG. 4a can also be used in the various modalities shown in FIG. 3. For example, the system can be calibrated and/or adjusted to reduce errors in substance detection (as opposed to errors in object estimation). Errors can be measured by the rate of false positives (system indicates that substance is present when it is not) and the rate of false negatives (system indicates that substance is not present when it is), for example. Two examples of metrics that may be used for object classification are the Fisher discriminant ratio and the Bhattacharyya distance.

FIG. 4b gives another example, which is depth estimation. The task here is to determine the depth to various objects. The object components are the portions of the object which are at different depths. The PIF inversion process can then be used, either directly or indirectly, to estimate the different depth components and hence the depth estimates. This metric can also be used in different modalities. FIGS. 4a-b give just two examples. Others will be apparent.

Returning to FIG. 1, the components within a plenoptic imaging system include the primary imaging subsystem 110, the secondary imaging array 120, the sensor array 130 and optionally a filter module 125. According to the invention, the plenoptic imaging system is constructed in a modular fashion, to allow the use of different plenoptic imaging components with a common body and/or to allow the interchangeability of different components within the plenoptic imaging system.

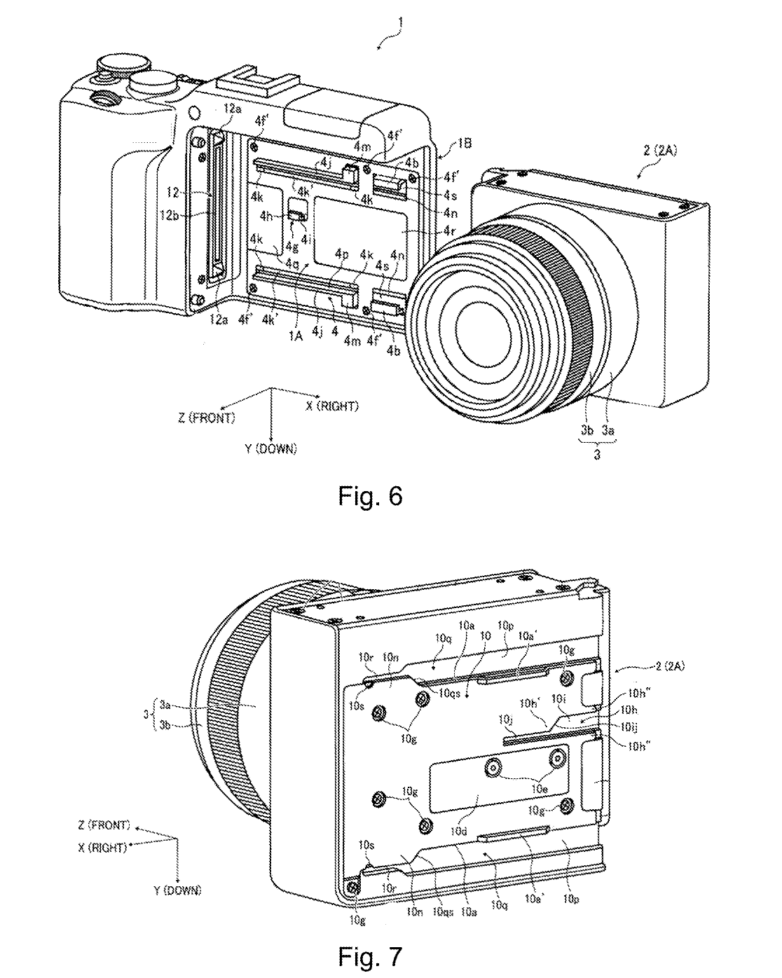

FIGS. 5-7 show a camera-based example, using a camera body 1 with a detachable plenoptic imaging unit 2. FIG. 5 shows the plenoptic imaging unit 2 attached to the camera body 1. FIG. 6 shows the imaging unit 2 detached from the camera body 1. FIG. 7 shows the rear of the plenoptic imaging unit. The plenoptic imaging unit 2 includes the primary imaging subsystem 110, the secondary imaging array 120 and the sensor array 130. In these figures, the plenoptic imaging unit 2 is shown as a single unit but, as will be described below, it may itself be constructed in a modulator fashion with detachable components. Since the plenoptic imaging unit 2 is detachable, different plenoptic imaging components may be used with the same camera body 1.

In this example, the imaging unit 2 has a cuboid shaped housing 2A. The housing 2A has a lens barrel 3 on its front face 2a. The lens barrel 3 includes a guiding cylinder 3a and a movable barrel 3b. The movable barrel 3b is placed on the guiding cylinder 3a so that the movable barrel 3b is capable of advancing or retreating in a direction in which an optical axis O extends. A lens system such as zoom lens or the like is provided on the movable barrel 3b.

The Z direction is parallel to the optical axis of the primary imaging system and is referred to as a front-back direction. The X direction is perpendicular to the optical axis, and referred to as a left-right direction. The Y direction is referred to as an up-down direction.

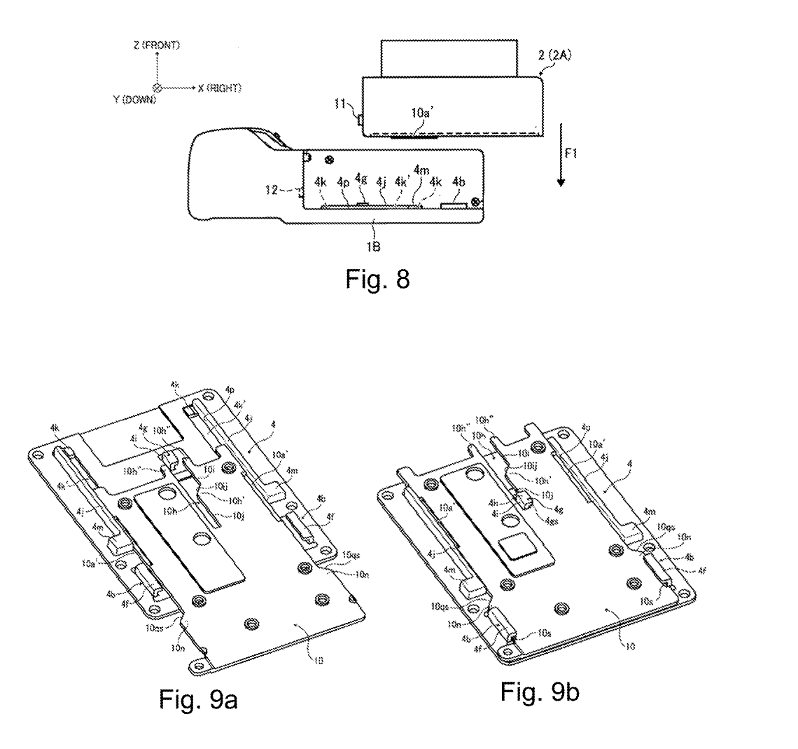

FIG. 8 is a bottom view explaining how the plenoptic imaging unit is attached to the camera body. The plenoptic imaging unit 2 is positioned against a rear part 1B of the camera body 1 by moving the unit 2 in a negative Z direction. Then, the plenoptic imaging unit 2 is moved to the left (negative X direction), to engage a camera-body connector 12 and a plenoptic imaging unit connector 11. Further features 12a,12b of the camera-body connector are shown in FIG. 6. The plenoptic imaging unit connector 11 has corresponding features. When engaged, the two connectors 11,12 provide an electrical interface between the camera body 1 and the plenoptic imaging unit 2.

The camera body 1 has a body rear wall reinforcing sheet metal member 4. The plenoptic imaging unit 2 has a corresponding unit rear wall reinforcing sheet metal member 10. These two members 4 and 10 engage and assist in the attachment of the camera body 1 and plenoptic imaging unit 2. Engagement of members 4 and 10 are shown in FIGS. 9a-b. FIGS. 9a-b show only these two members 4,10 and not the rest of the camera body 1 or the plenoptic imaging unit 2. In FIG. 9a, the two members 4,10 are partly engaged. In FIG. 9b, they are fully engaged. Additional features 4* and 10* of these two members 4,10 are also shown in the figures. A locking mechanism keeps the plenoptic imaging unit 2 in place once engaged. To disengage the two pieces, the plenoptic imaging unit 2 is unlocked and moved to the right (positive X direction). Further details (including a description of the electrical interface) are provided in U.S. patent application Ser. No. 12/916,948 “Camera body and imaging unit attachable to and detachable from camera body, and imaging apparatus” filed Nov. 1, 2010, which is incorporated herein by reference.

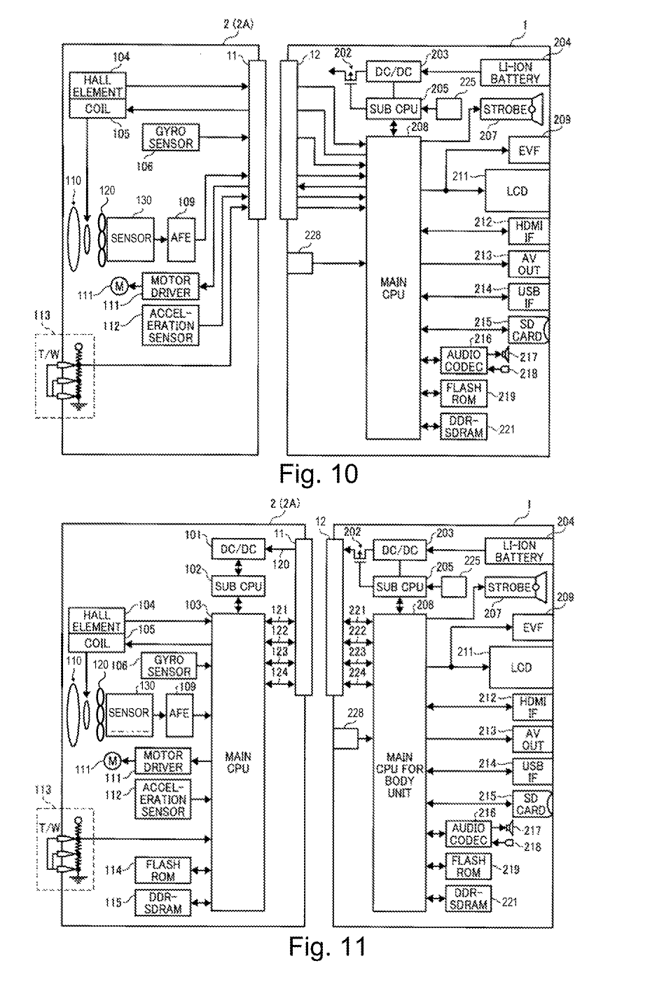

FIGS. 10-11 are block diagrams showing the electrical connections between a plenoptic imaging unit 2 and the camera body 1. The camera bodies 1 in both figures are the same, but the plenoptic imaging units 2 are different. The camera body 1 includes a lithium ion battery 204, a strobe light emitting section 207, an electronic viewfinder device 209, a liquid crystal display device (LCD) 211 having a display surface as a display section, a high-vision television connector interface (HDMIIF) 212, an audio-video (AVOUT) output terminal 213, an USB interface (USBIF) 214, an SD card interface (SD card) 215, an audio-codec circuit (Audio codec) 216, a speaker 217, a microphone 218, a flash ROM (Flash ROM) 219 as a recording medium which stores image data, a DDR-SDRAM 221, a main CPU 208 also functioning as a receiving section which receives image data, manipulation switches 225,228 which give an imaging instruction, a sub-CPU 205 as an imaging instruction receiving section which receives an imaging instruction from the manipulation switch 225, a DC/DC power circuit 203, a switching element 202, and a connector terminal 12. In an alternate design, the camera body 1 may also include a GPU in addition to the main CPU 208, or the main CPU 208 may be a GPU. Many of the above features are various types of electrical interfaces, for example for transferring data to a removeable storage medium or using a communications protocol.

The plenoptic imaging unit 2 includes an imaging lens unit 110 as the primary imaging subsystem, a microlens array 120 as the secondary imaging array and a sensor array 130. It also includes an AFE circuit 109, a hall element (Hall element) 104, a driving coil (Coil) 105, a gyro sensor (Gyro sensor) 106, a motor driver (Motor Driver) and drive motor (M) 111, an acceleration detection sensor 112, a Tele/Wide detection switch 113, and a connector terminal 11. The connector terminal 11 interfaces to connector terminal 12 on the camera body. Image data typically is transmitted over this interface. In this example, the functions of processor 140 of FIG. 1 typically would be performed by main CPU 208 or else by a processor that is external to the entire plenoptic imaging system.

The example shown in FIG. 11 is similar to FIG. 10, except that the plenoptic imaging unit 2 includes its own CPU 103 and/or GPU. A DC/DC power circuit 101, a sub CPU 102, a main CPU 103, a flash ROM 114, and a DDRSDRAM 115 are provided in the plenoptic imaging unit 2. In one embodiment, the main CPU 103 performs some or all of the functions of processor 140 in FIG. 1 (including possibly PIF inversion), and the post-processed signals are transmitted to the main CPU 208 by way of the connector terminals 11, 12. One advantage of this approach is that CPU 103 can be programmed to perform processing that is specific to this particular plenoptic imaging unit. In an alternative approach, the main CPU 103 performs compression processing, and transmits compressed image data to the main CPU 208 by way of the connector terminals 11, 12. The main CPU 103 can also perform other types of full or partial processing.

Local data storage on the plenoptic imaging unit (e.g., flash ROM 114) can also store parameters that describe the plenoptic imaging unit, for example parameters for the microlens array and/or sensor array. These parameters can be used by the CPU 103 or communicated to the body 1 to support processing functions. The architecture shown in FIG. 10 can also be revised so that the plenoptic imaging unit 2 includes local data storage, which is read via interface 11,12.

The electrical interface formed by connectors 11,12 can also be used for other purposes. For example, power can be provided by the camera body 1 to the plenoptic imaging unit 2 via the interface 11,12. The body may also include various user controls (e.g., zoom control), with corresponding instructions provided over the electrical interface 11,12 to control the plenoptic imaging unit.

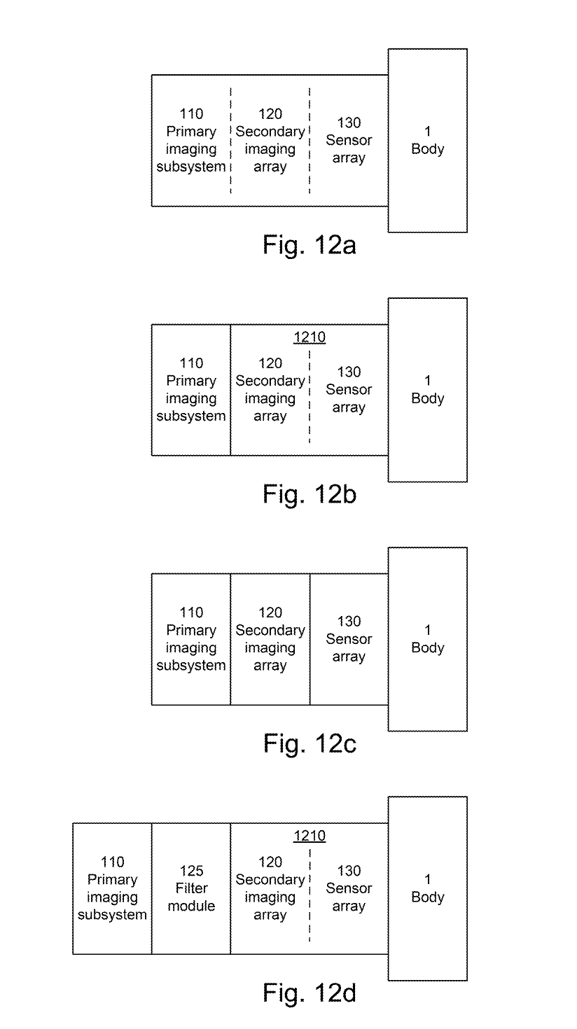

FIGS. 5-11 show one example. The invention is not limited to this example. FIG. 12a is a representation of the example shown in FIGS. 5-11. This representation shows the basic components: primary imaging subsystem 110, secondary imaging array 120, sensor array 130 and body 1. The solid lines show which components are constructed as an integrated unit. In the example of FIG. 12a, the plenoptic imaging unit is constructed as an integrated unit that includes the primary imaging subsystem 110, secondary imaging array 120 and sensor array 130.

FIGS. 12b-d show variations with different degrees of modularity. In FIG. 12b, the primary imaging subsystem 110 is also detachable from the rest of the plenoptic imaging unit. The remaining portion of the plenoptic imaging unit (i.e., the secondary imaging array 120 and sensor array 130) will be referred to as the plenoptic sensor unit 1210. In FIG. 12b, different primary lenses 110 can be attached to different plenoptic sensor units 1210.

In FIG. 12c, the plenoptic sensor unit is further modularized. The secondary imaging array 120 and sensor array 130 are also detachable from each other. For example, different microlens arrays may then be attached to the same sensor. This can be used to support the use of different size microlenses. In one application, it might be desirable for a microlens to cover K sensor pixels, whereas it might be desirable to cover N sensor pixels in a different application. The architecture in FIG. 12c would facilitate the changing of microlens arrays (or other secondary imaging arrays). Since the microlens array 120 and sensor array 130 typically will be physically close to each other, it may be challenging to create detachable versions while maintaining the close spacing. Optical relays can be integrally attached to either the microlens array or the sensor array, in order to relax this mechanical spacing requirement.

In FIG. 12d, the filter module 125 is added as yet another detachable component. In this example, the secondary imaging array 120 and sensor array 130 are integrally attached to each other to form a single unit, but the filter module 125 and primary imaging subsystem 110 are implemented as separate detachable units. Again, optical relays can be used to relax spacing requirements.

Other variations will be apparent. For example, in an SLR camera, the primary lens 110 may have a mechanical zoom implemented by a movable barrel in a guide cylinder. See components 3b and 3a in FIGS. 5-7. Similarly, the primary lens, lenslet array/secondary imaging array and/or sensor array shown in FIGS. 12a-d may each have similar mechanisms to allow flexibility to change their z positions with respect to each other as different combinations of components are used.

Although the detailed description contains many specifics, these should not be construed as limiting the scope of the invention but merely as illustrating different examples and aspects of the invention. It should be appreciated that the scope of the invention includes other embodiments not discussed in detail above. For example, the detailed example described above used a “camera” body, but the invention is not limited to cameras. It can also be applied to other imaging systems, including microscopes. For microscope, the primary lens can be changed by switching between different objective lenses. Examples of other imaging systems include systems with fisheye optics, omnidirectional cameras, security cameras (which may use a simpler body if some of the controls are performed remotely), remote sensing cameras, and motion picture cameras. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

In the claims, reference to an element in the singular is not intended to mean “one and only one” unless explicitly stated, but rather is meant to mean “one or more.” In addition, it is not necessary for a device or method to address every problem that is solvable by different embodiments of the invention in order to be encompassed by the claims.

What is claimed is:

1. A modular plenoptic imaging system comprising:
a body; and
a plenoptic sensor unit that is detachably attachable to the body, the detachable plenoptic sensor unit including a secondary imaging array and a sensor array, the secondary imaging array imaging a pupil of a primary imaging subsystem to the sensor array.

2. The modular plenoptic imaging system of claim 1 wherein the primary imaging subsystem is detachably attachable to the plenoptic sensor unit.

3. The modular plenoptic imaging system of claim 1 wherein the secondary imaging array and the sensor array are detachable from each other.

4. The modular plenoptic imaging system of claim 1 further comprising a filter module.

5. The modular plenoptic imaging system of claim 6 wherein the filter module is detachable from the plenoptic sensor unit.

6. The modular plenoptic imaging system of claim 6 wherein the filter module is detachable from the primary imaging subsystem.

7. The modular plenoptic imaging system of claim 6 further comprising an optical relay that is integrally attached to the filter module.

8. The modular plenoptic imaging system of claim 6 wherein the filter module includes spectral filters.

9. The modular plenoptic imaging system of claim 6 wherein the filter module includes spectral filters adapted for substance detection.

10. The modular plenoptic imaging system of claim 1 wherein each of the body and the detachable plenoptic sensor unit has an electrical connector that provide an electrical interface when the plenoptic sensor unit is attached to the body.

11. The modular plenoptic imaging system of claim 12 wherein the detachable plenoptic sensor unit includes a processor that communicates with the body via the electrical interface.

12. The modular plenoptic imaging system of claim 13 wherein the processor executes a PIF inversion process based on data captured by the sensor array.

13. The modular plenoptic imaging system of claim 13 wherein the detachable plenoptic sensor unit further includes local data storage that stores parameters describing the plenoptic sensor unit.

14. The modular plenoptic imaging system of claim 12 wherein the body further includes a second electrical interface.

15. The modular plenoptic imaging system of claim 15 wherein the second electrical interface is for transferring data to a removeable storage medium.

16. The modular plenoptic imaging system of claim 15 wherein the second electrical interface is for transferring data using a communications protocol.

17. The modular plenoptic imaging system of claim 12 wherein the plenoptic imaging unit receives power from the body via the electrical interface.

18. The modular plenoptic imaging system of claim 12 wherein the body includes a user control, and the input received via the user control controls the plenoptic imaging unit via the electrical interface.

19. The modular plenoptic imaging system of claim 1 wherein the body is a camera body.

20. A plenoptic sensor unit that is detachably attachable to an imaging system body, the detachable plenoptic sensor unit including a secondary imaging array and a sensor array, the secondary imaging array imaging a pupil of a primary imaging subsystem to the sensor array.
